(19) United States
(12) Patent Application Publication
(10) Pub. No.: US 2014/0129237 A1
(43) Pub. Date: May 8, 2014

(54) ESTIMATING MARKET-DRIVEN MEDICAL FACILITY RATES AND/OR CHARGES

(71) Applicants: Benjamin Ryan Wornell, Portland, OR (US); Frederick William Stephens-Tiley, Lake Oswego, OR (US); Erik Richard Nolke, Portland, OR (US); Michael Allen Parker, Portland, OR (US); Merrit Laird Quarum, Portland, OR (US)

(72) Inventors: Benjamin Ryan Wornell, Portland, OR (US); Frederick William Stephens-Tiley, Lake Oswego, OR (US); Erik Richard Nolke, Portland, OR (US); Michael Allen Parker, Portland, OR (US); Merrit Laird Quarum, Portland, OR (US)

(73) Assignee: QMEDTRIX SYSTEMS, INC., Portland, OR (US)

(21) Appl. No.: 13/668,202

(22) Filed: Nov. 2, 2012

(51) Int. Cl. G06Q 50/22; G06Q 30/02

(52) U.S. Cl. CPC G06Q 50/22; G06Q 30/0206
USPC 705/2

(57) ABSTRACT

Embodiments of methods or apparatus to estimate market-driven medical facility rates and/or charges are provided.

### BACKGROUND

1. Field

This disclosure relates to estimating medical facility rates and/or charges.

2. Information

For a variety of reasons, medical facility charges, typically subject to some reimbursement through insurance, that may be billed to a patient and may be associated with a medical procedure, for example, may not result from market forces, such as supply and demand. In healthcare, for example, intrusion by third parties, such as insurance companies, government entities, and/or so forth, may affect charges for goods and/or services that would otherwise result from a properly functioning market. There may also be other reasons for markets to not operate in accordance with supply and demand, such as price opacity. A variety of issues may arise in connection with medical services, in particular, if market forces are not driving charges. For example, in an ideal market medical services should be over consumed if charges are reduced relative to market-driven rates or under consumed if charges are higher relative to market-driven rates. However, this dynamic does not hold true for the Health Care industry for reasons that are not entirely clear. Furthermore, insurance companies, which may employ charges to set levels of reimbursement to insured parties, may over or under reimburse if charges are significantly out of line with market forces, for example.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, may best be understood by reference to the following detailed description if read with the accompanying drawings in which:

FIG. 1 is a schematic diagram illustrating an embodiment that may include a computing platform in accordance with claimed subject matter;

FIG. 2 is a flow diagram illustrating an embodiment of a method in accordance with claimed subject matter;

FIG. 3 is a flow diagram illustrating another embodiment of a method in accordance with claimed subject matter;

FIG. 4 is a flow diagram illustrating still another embodiment of a method in accordance with claimed subject matter;

FIG. 5 is a schematic diagram of an embodiment of a computing platform that may be employed to perform an embodiment of a method in accordance with claimed subject matter;

FIG. 6 is a plot illustrating a hypothetical situation; and

FIG. 7 is a flow diagram illustrating yet another embodiment of a method in accordance with claimed subject matter.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and/or so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example,” “one feature,” “one embodiment,” “an example,” “a feature,” or “an embodiment” means that a particular feature, structure, or characteristic described in connection with a feature, example or embodiment may be included in at least one feature, example or embodiment of claimed subject matter. Thus, appearances of the phrase “in one example,” “an example,” “in one feature,” “a feature,” “an embodiment,” or “in one embodiment” in various places throughout this specification are not necessarily all referring to the same feature, example, or embodiment. Furthermore, particular features, structures, or characteristics may be combined in one or more examples, features, or embodiments.

For a variety of reasons, medical facility charges, typically subject to some reimbursement through insurance, that may be billed to a patient and may be associated with a medical procedure, for example, may not result from market forces, such as supply and demand. In healthcare, for example, intrusion by third parties, such as insurance companies, government entities, and/or so forth, may affect charges for goods and/or services that would otherwise result from a properly functioning market. There may also be other reasons for markets to not operate in accordance with supply and demand, such as price opacity. A variety of issues may arise in connection with medical services, in particular, if market forces are not driving charges. For example, in an ideal market medical services should be over consumed if charges are reduced relative to market-driven rates or under consumed if charges are higher relative to market-driven rates. However, this dynamic does not hold true for the Health Care industry for reasons that are not entirely clear, but may be at least partially due to complexity of relevant markets. Furthermore, insurance companies, which may employ charges to set levels of reimbursement to insured parties, may over or under reimburse if charges are significantly out of line with market forces, for example.

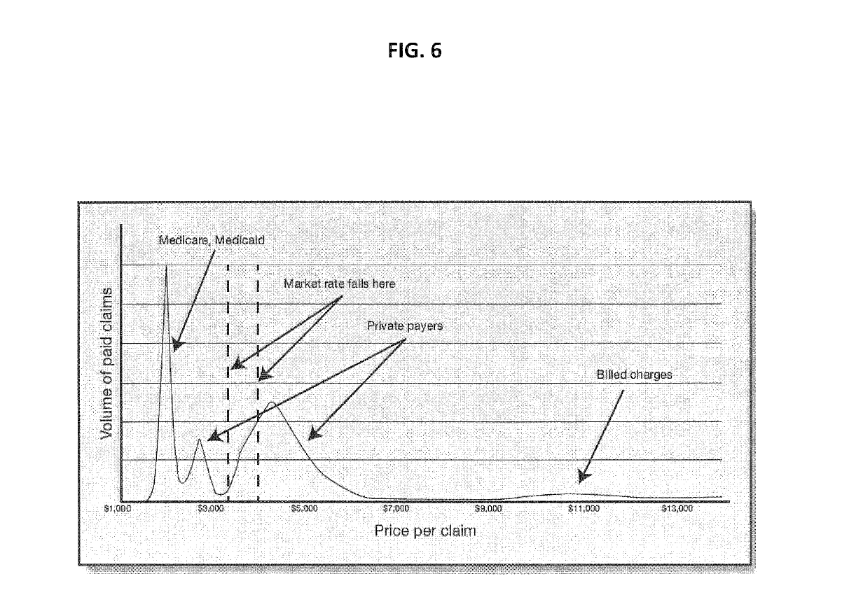

As an illustration, FIG. 6 is a plot of a hypothetical example. A market rate for services at a medical facility, for example, is shown as lower than billed charges. As illustrated, a high volume of Medicare and private payer paid claims tend to pull the market rate away from billed charges, representing a more realistic picture of what providers in a given health care market may receive in payments for a given procedure, for example.

It is noted that for a particular measurement, whether measuring temperature, pressure, voltage, current, or market-driven rates, for example, a typical measurement model employed is that a measurement taken comprises a sum of at least two components, a deterministic component, which in an ideal sense, comprises a value sought as a result of taking a measurement, and a random component, which may have a variety of sources that may be challenging to quantify accurately. Thus, a statistical model may be used. A large number of measurements may be collected, for example, to better estimate a deterministic component.

Likewise, where measurements vary, some portion of a variance may be explained as a deterministic component while some portion of a variance may be explained as a random component. Typically, it is desirable to have a variance associated with and/or modeled as statistically random factors be relatively small, if feasible.

Along these lines, a variety of techniques have come into use so that measurements may be processed to better estimate an underlying deterministic component, as well as realized random components typically. These techniques may vary with a particular situation. Typically, however, more complex problems involve more complex techniques. In this regard, market-driven medical facility rates are similar to an estimation of other measurable characteristics. Measurements may be collected. Employing a model permits collected measurements to be processed to estimate an underlying deterministic component. Although a given estimate may not be a perfect estimate, in general, it is expected that on average an estimate may better reflect an underlying deterministic component if random components that may be included in measurements are considered. Practically speaking, of course, it is desirable to be able to generate, such as through estimation approaches, a meaningful model of processes affecting measurements.

In some situations, as indicated, potential influences may be complex, as in the case of medical facility rates and/or charges. Therefore, seeking to understand appropriate factors to consider for generating estimates of market-driven medical facility rates and/or charges may be particularly challenging. For example, here, as only a few examples, influences on medical costs, charges and/or rates may include, for example, regulatory mandates, effect of insurance reimbursement, quality and/or availability of resources, differences in services provided, and/or internal cost accounting. In such situations, it is, therefore, not unusual to employ heuristics in connection with generating estimates. Heuristics refers to use of experience related approaches that may reflect realized processes and/or realized results, such as in connection with use of historical measurements, for example. Heuristics, for example, may be employed in situations, such as this, where more analytical approaches may be overly complex and/or nearly intractable.

Throughout this document, the meaning of terms, such as the term cost, charges, rates and/or reimbursement, may be understand from usage in particular contexts, which may reflect subtle nuances of meaning. However, at a high level, cost refers to an amount incurred by a medical facility in connection with providing a product and/or service, charge refers to an amount that a medical facility may bill in connection with providing a product and/or service, which may at times exceed cost, as simply an example, and rate refers to an amount paid for a provided product and/or service, which may at times be less than a charge, as simply an example. Likewise, the term reimbursement refers to measurements of rate, such as an amount an individual or insurance, for example, may have paid in the past with reference to particularly identified products and/or services. Likewise, the term market-driven if used with a term, such as the term rate, that is, in this example, market-driven rate refers to an estimate of rate as would result if market forces, such as supply and demand, were in equilibrium or were reasonably close to equilibrium.

According to one or more implementations, as described in detail herein, a method to estimate market-driven medical facility rates and/or charges may be provided. In an implementation, a “base market” may be determined which may provide a foundation for estimating an average associated medical facility cost, charge and/or rate for a medical procedure, for example, within a particular geographical region. Likewise, an average medical cost, charge and/or rate may be estimated with respect to a particular payer or set of payers, such as, for example, but without limit, Centers for Medicare and Medicaid Services (referred to as CMS or Medicare herein), or other government entity, for example. A base market may comprise an initial number of medical facilities, such as at least three medical facilities within a certain range, such as 240.0 km, for example, measured in one possible implementation as roughly radially.

Measurements of historical reimbursements (e.g. of medical claims) associated with medical procedures may be grouped in various ways for estimation purposes. In a geographic region, for example, medical procedures may be grouped. Throughout this document, the meaning of terms, such as the terms group, medical code and/or medical procedure, may be understand from usage in particular contexts, which may reflect subtle nuances of meaning. However, at a high level, a group refers to a set of reasonably similar medical procedures where, as a result of similarity, associated costs, charges and/or rates, for example, may likewise be similar. As an example, a group may be are associated with one or more ambulatory procedure codes (APCs), such as if it is expected that the one or more APC codes include similar medical procedures. Likewise, medical procedures may be grouped in other ways that are intended to result in a group of similar medical procedures, such as for rate and/or charge estimation purposes, for example. The term medical procedure refers to a service provided to a patient by a medical provider in a service location such as a hospital or outpatient setting. There are, of course, a significant number of medical procedures. A medical code, such as, for example, a current procedural terminology (CPT) code, provides one mechanism available for identifying different medical procedures. Thus, a separate CPT code is intended to identify separate medical procedures. In this context, therefore, an APC code is not a medical code. An APC code may in some circumstances comprise a group, but does not necessarily do so, in this context.

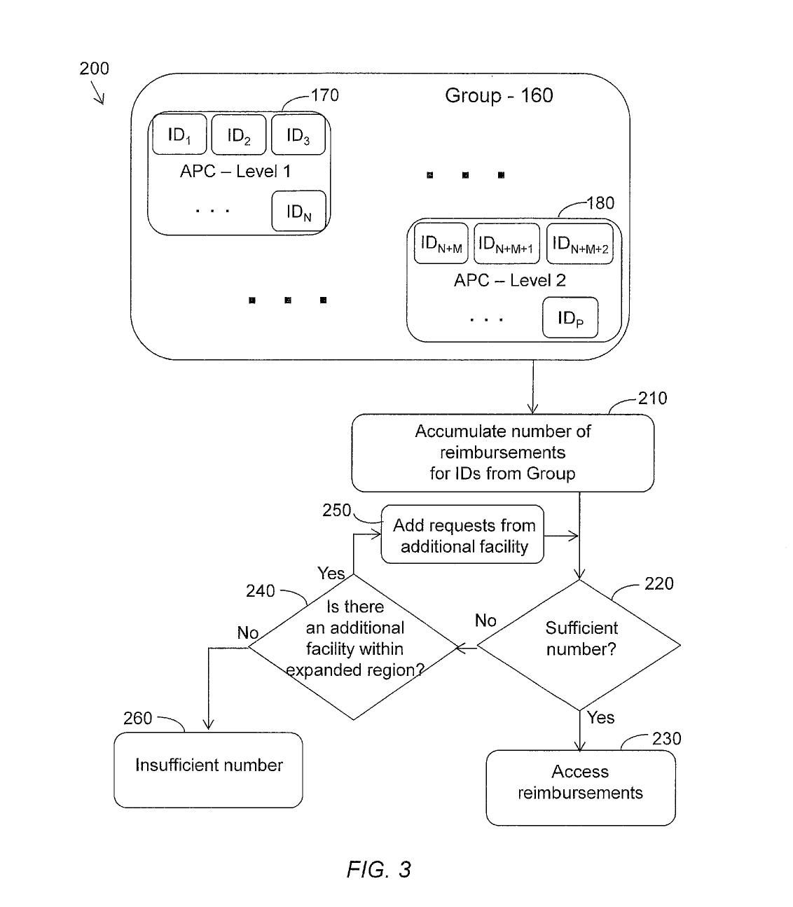

As simply an illustration, in one possible example among many, referring to group 160, shown in FIG. 3, for example, that group may be intended to pertain to APCs concerned with arthroscopic surgery. Accordingly, APC-Level 1 170 may correspond to level 1 arthroscopic surgery (APC 0041), in which ID₁ may correspond to Current Procedural Terminology (CPT) code 29800, jaw arthroscopic/surgery. ID₂ may correspond to CPT code 29822 (shoulder arthroscopy/surgery) and so forth. Further, APC-Level 2 may correspond to level 2 arthroscopic surgery, such as APC 0042. Within APC-level 2 180, ID_{N+M}, for example, may correspond to CPT code 29868, (arthroscopy, knee, surgical, osteochondral autograft). Although group 160 of FIG. 3 shows only APC-Level 1 170 and APC-Level 2 180, group 160 may include additional levels, such as 3, 4, and/or 5, that may correspond to possible levels for other ambulatory procedure codes, for example.

In addition, as explained below, in an implementation or embodiment, a relative value may be estimated, such as by computing a relative value unit, to allow normalization across varying medical procedures, for example. In an embodiment, for example, normalization may be used to estimate a facility cost factor (CF) such as may be associated with a group of medical procedure codes in a geographic region, again, as an example, for CMS, as previously mentioned. An estimate of an associated facility cost factor, such as for a group and in a geographic region, as an example, may include normalization by an estimate of relative value, which may be used in connection with estimating costs, charges and/or rates, such as for a group and in a geographic region, continuing with the example. In an implementation, a relative value unit may be used to estimate relative value, as shall be explained in more detail below.

In an implementation, it may also be desirable to process measured historical reimbursements, such as may correspond to one or more specific medical procedure(s), for example, to have more accurate measurements for use in estimation. As an example, historical reimbursement measurements may comprise medical claims available from Medicare. Medicare makes publicly available payments made for certain medical procedures categorized in accordance with current procedural terminology (CPT) codes, in particular as reimbursement information available through its Outpatient Prospective Payment System (OPPS). Various adjustments may be made to have more accurate historical reimbursement measurements. For example, an implantable device, such as a pacemaker, a stent, or the like, may be excluded (and later perhaps added back separately) because Medicare, for example, averages costs and/or charges of an implant across many individuals rather than attributing it directly to those individuals receiving the implant. In other examples, historical reimbursements involving multiple procedures may be excluded due at least in part to complexities associated with measurement of sharing costs and/or charges across separate medical procedures.

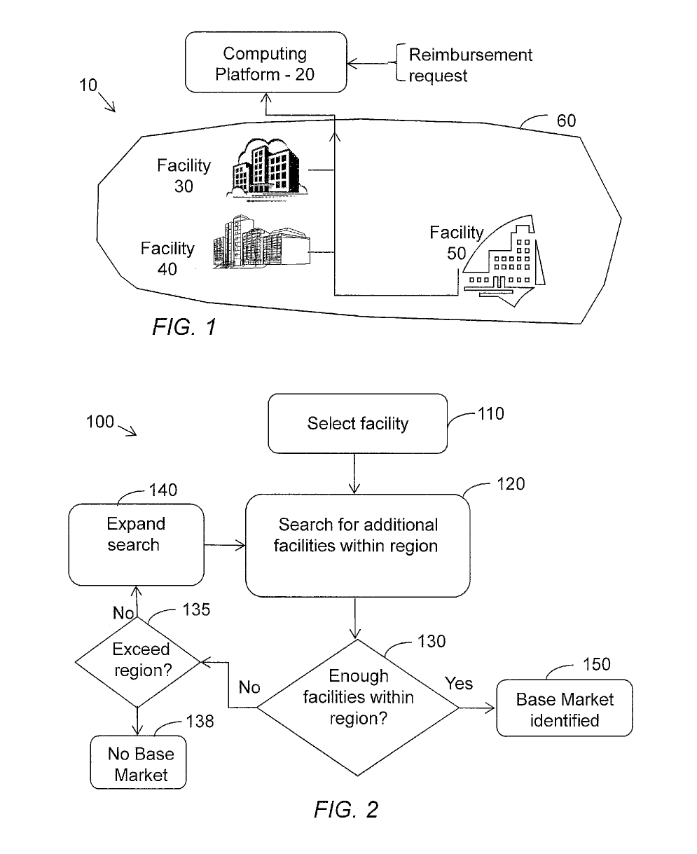

FIG. 1 is a diagram showing an embodiment 10 that may, for example, as shown, include a computing platform or similar computing device. In FIG. 1, computing platform 20, may, for example, include a capability to communicate with one or more facilities, such as, for example, facility 30, facility 40, and/or facility 50, which may represent hospitals, outpatient centers, clinics, or other facilities that provide medical care, for example. Networking via the internet or an intranet may allow communications in an embodiment. Of course, in alternate embodiments, network communications may not be employed or other types of communications other than network communications may be utilized.

Typically, a facility providing medical services, such as, for example, facilities 30, 40, and/or 50, may provide staff, supplies, medications, and/or rooms associated with one or more medical procedures. It is noted that, of course, one or more medical providers may, for example, provide services at facilities 30, 40, and/or 50, and may, therefore, be included as a cost and/or charge associated with providing medical services in the form of a medical procedure, for example. However, it is likewise noted professional fees typically may not be correlated with medical facility costs, charges and/or rates. Therefore, professional fees may not be included in historical reimbursements for at least one embodiment. Of course, in an embodiment, claimed subject matter may include estimating market-driven medical personnel rates and/or charges, such as associated with a medical procedure, medical code, and/or group, for example, in addition to estimating market-driven medical facility rates and/or charges. For example, if a database of professional fees were available and employed, a similar approach may be employed to estimate market-driven charges and/or rates, although claimed subject matter is not limited in scope in this respect.

Facilities 30, 40, and/or 50 may be dispersed throughout a geographical region, such as a city, county, or state, and may, as previously explained in an embodiment, communicate with computing platform 20. However, other mechanisms may likewise be employed so that a reimbursement request, for example, may be conveyed. For example, in an implementation, such as FIG. 1, a reimbursement request may be received at computing platform 20. That is, an insurance payer, for example, may desire to evaluate a reimbursement request. Therefore, an insurance payer may query computing platform 20 to evaluate market-driven rates with respect to a medical facility, for example. For example, a request may indicate a medical procedure that was performed. Likewise, the medical procedure may fall within a particular group, for example. It is, of course, appreciated that examples provided are merely illustrative. Illustrative examples may be less complex for such purposes without intending, of course, to limit claimed subject matter.

As a result of receiving a reimbursement request, computing platform 20 may seek to identify a base market 60 for a medical facility, such as the facility indicated by the request. In an implementation, computing platform 20 may identify facilities, such as facilities 30, 40, and/or 50 to estimate market-driven medical facility rates and/or charges associated with a particular group that includes the medical procedure in a particular geographical region that includes the particular medical facility, for example.

FIG. 2 is a flow diagram illustrating an embodiment 100 of a method that may be employed in conjunction with estimating market-driven medical facility rates and/or charges, for example. The method embodiment of FIG. 2, along with other figures shown and/or described herein, may be performed by computing device 20, for example, although nothing prevents performing other method embodiments within claimed subject matter. Likewise, a method embodiment, such as embodiment 100, may be performed by way of other arrangements other than the embodiment shown in FIG. 1, for example. Further, claimed subject matter may include additional blocks or alternatives other than those shown in FIG. 2 and/or may include blocks occurring in different orders than shown and/or described.

At block 110 of FIG. 2, a computing platform may, for example, identify a medical facility in a geographic region. For example, a medical facility may correspond to one requesting evaluation or for which evaluation may have been requested in an embodiment. At 120, a computing platform may search for additional facilities within a first distance that may roughly correspond to a geographic region radially distributed at least approximately around an initial facility, for example. Of course, claimed subject matter is not limited in scope in this respect. As explained in more detail below, geographic region may be sized in a manner to correspond roughly to a relevant market. Thus, a variety of approaches may be employed to assess an appropriate geographic region, including publicly available information about topology, known urban or rural areas, etc. However, for purposes of illustration, to a first approximation, a rough radial distribution of a first distance may be satisfactory for a possible base market that includes an initial facility for evaluation to generate an estimate. It is noted that use of zip codes or similar seemingly arbitrary governmental or governmental-like divisioning of areas is specifically not employed in assessing a geographic region for a base market.

In one or more implementations, a base market for a medical facility may, for example, include an initial or target number of facilities, such as three medical facilities (e.g., facilities providing medical services, such as hospitals or outpatient clinics, for example) located within an appropriate radius, such as approximately 240.0 km (approximately 150.0 miles). However, in other implementations, a base market for a medical facility may include a smaller number of facilities, such as two or fewer, or may include a larger number of facilities, such as five facilities or more. It should be noted that claimed subject matter is not limited to a particular number of medical facilities used to establish a base market; rather, depending at least in part on a variety of potentially complex factors, a base market may comprise more medical facilities or fewer medical facilities. In some implementations, it may be desirable for medical facilities comprising a base market to be located within an approximate distance, such as 240.0 km. However, some implementations may make use of a base market comprising medical facilities located within smaller distances, such as less than approximately 240 km, or may make use of medical facilities located within greater distances, such as 300.0 km, 400.0 km, and so forth, and claimed subject matter is not limited in this regard. Size of a geographic region for a base market, similar to number of medical facilities, may depend at least in part on a variety of potentially complex factors and, therefore, claimed subject matter is not limited in scope in this regard. For example, it is desirable for a geographic region to include a number of medical facilities to collect a statistically sufficient number of historical reimbursement measurements; however, likewise, an overly large geographic region may include multiple markets and, consequently, may provide less accurate historical reimbursement measurements. In this context, the term statistically sufficient number of measurements refers to enough measurements, such as with respect medical claim reimbursements, for example, so that a potential effect of significant errors or outliers on estimation of an underlying non-statistical value is reduced to an acceptable level of risk. In this context, the term base market refers to a geographic region that includes enough medical facilities with enough measurements of reimbursement so as to estimate an appropriate level or amount for market-driven medical facility rates and/or charges. Likewise, as indicated above, this region is not necessarily limited to a roughly radially distributed region.

At 130, a determination may be made as to whether an appropriate or target number of medical facilities are within a region or at least known to be within a region. In the event that a target number of medical facilities, for example, three, are not known to be within a geographic region, at block 135, another search radius may be evaluated that may be expanded compared to a prior search radius. However, a search radius that has been expanded may exceed a radius that may be used, in an embodiment, for example, to limit a size of a geographic region for a base market, such as discussed above, for example. If a radius has been exceeded by a search radius, at block 138, for example, a base market may not be able to be identified. If a radius has not been exceeded, however, at block 140, an expanded search radius may be used to locate additional medical facilities.

In an example implementation, a search radius may start at 15.0 km and may be expanded in approximately 15.0 km increments, for example, although, of course, claimed subject matter is not limited in this regard. For example, in other implementations, increases in search radii of, for example, 14.0 km or less, or increases in search radii of, for example, 16.0 km or more may be employed. Similarly, in other implementations, a different initial search radius may be employed.

If a search area or region, however, has been expanded, at block 120, additional medical facilities may be sought. Following a second execution of block 120, for example, continuing with the previous example, a determination may be made, at block 130, as to whether a sufficient number of medical facilities within a region have been identified or located. If a sufficient number of medical facilities have been identified or located, at block 150 it may be determined that a base market corresponding to the particular region including the identified facilities has been potentially identified.

FIG. 3 is a flow diagram illustrating an embodiment 200 of another method that may be employed in conjunction with estimating market driven medical facility rates and/or charges, for example. The method embodiment of FIG. 3, along with other figures shown and/or described herein, may be performed by computing device 20, for example, although nothing prevents performing other method embodiments within claimed subject matter. Likewise, a method embodiment, such as embodiment 200, may be performed by way of other arrangements other than the embodiment shown in FIG. 1, for example. Further, claimed subject matter may include additional blocks or alternatives other than those shown in FIG. 3 and/or may include blocks occurring in different orders than shown and/or described.

In an implementation, individual medical procedure codes, such as CPT codes, as previously indicated, may in an example, comprise a group of similar APC codes, such as group 160. Of course, this is merely an illustrative example and claimed subject matter is not intended to be limited to illustrations. Thus, a group may be characterized with medical procedures and/or medical codes in a variety of ways other than use of APC codes, for example. Nonetheless, continuing with this illustration, medical procedure codes, such as CPT codes, for example, may pertain to one or more similar ambulatory procedure codes (APCs). One benefit of grouping procedures, such as by similar APCs or by another method, is that it may result in a greater number of historical reimbursements for evaluation, although claimed subject matter is not limited in scope in this regard.

At block 210, historical reimbursement measurements available for CPT codes from a group, as an example, may be accumulated from medical facilities comprising a base market. As an example, Medicare makes available a database of historical reimbursement measurements that may be employed, as mentioned previously; although other sources may also be used if available. Furthermore, several years of historical reimbursement measurements may be employed to obtain a greater number of sample measurements. Thus, continuing with FIG. 3, at 210, as an example implementation, it may be desirable for at least 11 historical reimbursements for a group to be available as measurements within a base market. However, it should be noted that in some implementations, for example, fewer than 11 reimbursements may be considered sufficient, such as fewer than 10. In other implementations, a greater number of reimbursements may be employed for a sample, such as 12, 15, 20, or an even greater number, and claimed subject matter is not limited in this respect. It should be noted that claimed subject matter is not limited to a particular number in a base market; rather, this may depend at least in part on a variety of potentially complex factors, such as an acceptable level of risk and/or variability of results, for example. As previously discussed, in an embodiment, it may be desirable to have a statistically sufficient number of measurements.

At block 220, a determination may be made as to whether a statistically sufficient number of historical reimbursement measurements are available. If a sufficient number, such as 11, are not available, such as from a database, as previously described, at block 240, a search for an additional facility through an expanded search radius of up to approximately 240.0 km, may take place, as described above, assuming doing so would not exceed an acceptable size (e.g., radius) for a base market, as previously described in connection with FIG. 2, for example. In an implementation, a search for an additional facility or facilities may take place using increments such as 15.0 km, in which, if at least one additional facility is found, historical reimbursements for group 160 may be counted, such as at block 250. A database in a local or non-local memory, for example, may be accessed by a computing platform, such as at block 230, for example, so that a statistically sufficient number may be counted at block 220. If executing block 240 indicates that a statistically sufficient number of reimbursements cannot be identified, at block 260 a determination may be made that a sufficient number cannot be found. Of course, this example is merely illustrative and claimed subject matter is, of course, not limited in scope to illustrative examples.

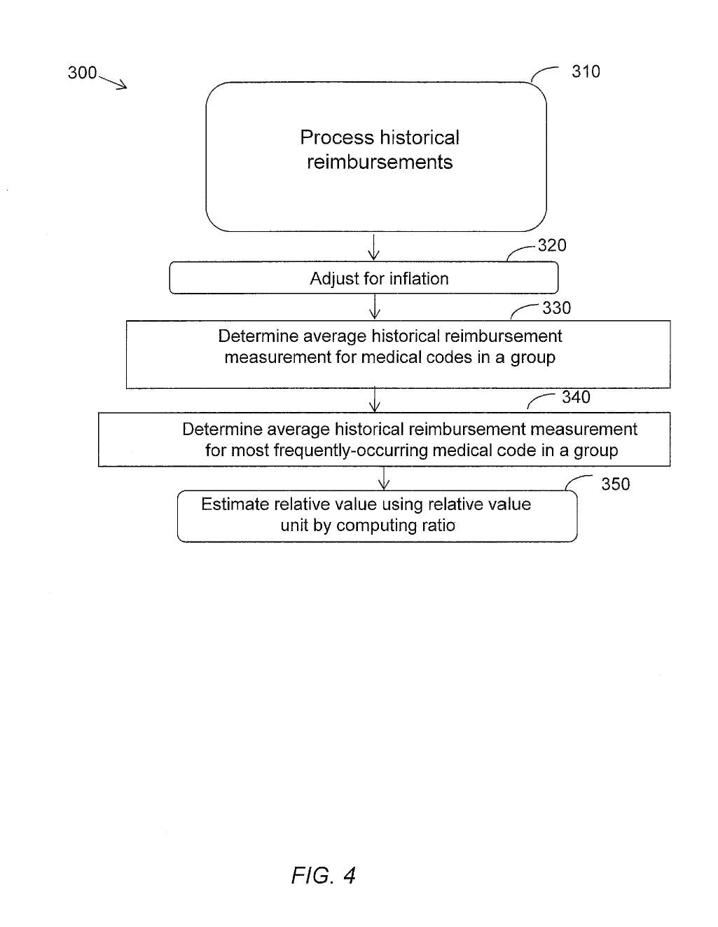

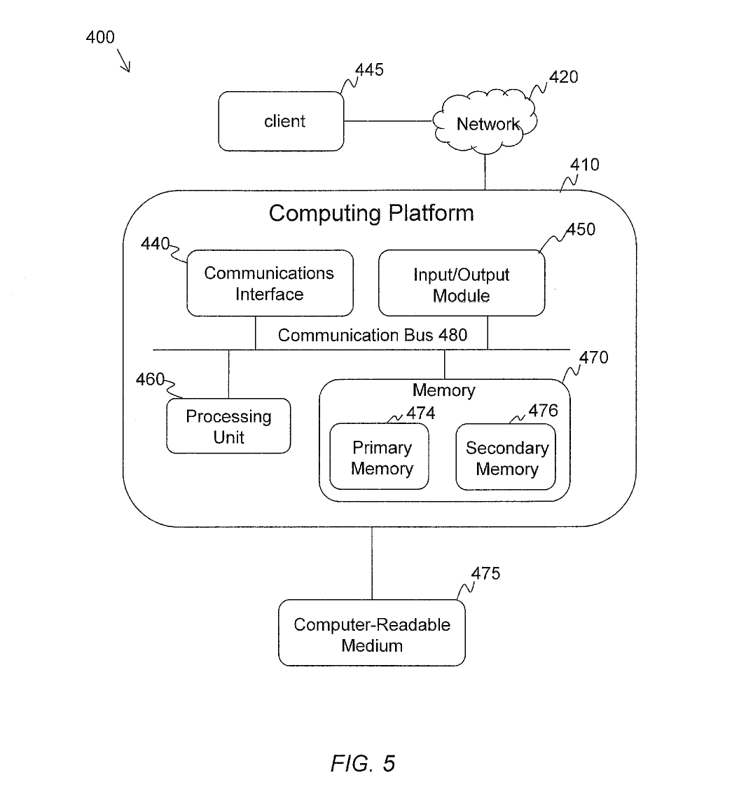

FIG. 4 is a flow diagram of illustrating an embodiment 300 of another method that may be employed in conjunction with estimating market-driven medical facility rates and/or charges. For example, a relative value unit may be estimated, such as for a group in an embodiment. The method embodiment of FIG. 4, along with other figures shown and described herein, may be performed by computing device 20, for example, although nothing prevents performing other method embodiments within claimed subject matter. Likewise, a method embodiment, such as embodiment 300, may be performed by way of other arrangements other than the embodiment shown in FIG. 1, for example. Further, claimed subject matter may include additional blocks or alternatives other than those shown in FIG. 4 and/or may include blocks occurring in different orders than shown and/or described.

Embodiment 300 of FIG. 4 may begin at block 310, in which historical reimbursements, for example, available from a database, as previously described, may be processed to provide more accurate measurements of medical facility cost, charges and/or rates associated with medical procedures, such as a group in an embodiment, for example. Processing may depend at least in part on a source or source(s) of historical reimbursement measurements. For example, as previously described, Medicare may provide such measurements. Therefore, in implementations in which Medicare historical reimbursement measurements are employed, processing may be employed so that measurements may be more accurate. For example, as previously described, CPT codes for single minor and single major procedures may be employed; however, multiple procedures may be omitted. In an implementation, for example, single minor and single major procedures may correspond to CPT codes of group 160 having a status indicator S or T. Likewise, at block 310, as previously described, historical reimbursements may be adjusted to remove implant costs and/or charges. In addition, in some instances, laboratory tests may have been billed and reimbursed that are not necessarily associated with the particular medical procedure for which reimbursement was paid. Therefore, historical reimbursements may be adjusted to omit such costs and/or charges. It should be noted that additional adjustments may be made; depending at least in part on CPT code and/or source of measurements, and claimed subject matter is not limited in this respect. It is noted that after historical reimbursement measurements of facility costs and/or charges are processed, such measurements may be used to generate a variety of estimates. For example, as previously described, measurements may be used to estimate market-driven rates and/or charges, such as for a group in a geographic region, for example; however, in addition, for example, as explained below and illustrated in FIG. 4, likewise, measurements may be used to estimate a relative value, such as by computing a relative value unit.

For example, in an implementation, measurements of costs and/or charges, for example, may be used to estimate a relative value, such as for a group in a geographic region, as an example. An estimate of relative value, such as a relative value unit, may be employed to normalize an estimate of facility costs, charges and/or rates. Thus, a cost factor, such as a public insurance cost factor, may be estimated using an estimate of relative value to normalize an average value, such as may be computed to estimate facility costs, charges and/or rates in an embodiment, for example. Likewise, a cost factor may be estimated by employing a healthcare producer price index (PPI) and a charge factor may be estimated by employing a healthcare consumer price index (CPI), as explained in more detail below. It is noted that a variety of such indices exist including those which may be made publicly available by the US government. Thus, estimates of inflation from the US government or others that may be available may be employed. Thus, at block 320, historical reimbursements may also be adjusted for inflation using an index, such as a healthcare PPI or healthcare CPI as appropriate. By adjusting for inflation, measurements from one or more past years may be adjusted to reflect a present year. In this particular embodiment, adjustments may correspond to a particular quarter of a particular year, for example.

A method embodiment may continue at block 330, which may include determining an average for a plurality of medical codes, such as CPT codes (ID₁, ID₂, . . . , ID_{N+M}, . . . IDₚ), which, for ID₁, occurring “j” times, ID₂, occurring “k” times, and so forth, up to and including IDₚ, occurring “l” times, may be expressed substantially in accordance with the following:

$$Avg ( I {D}_{1} ) = \frac{1}{j} {\sum }_{1}^{j} I {D}_{1} , \\ Avg ( I {D}_{2} ) = \frac{1}{k} {\sum }_{1}^{k} I {D}_{2} , … , Avg ( I {D}_{p} ) = \frac{1}{l} {\sum }_{l}^{1} I {D}_{P} .$$

At block 330, an average amount for medical codes in a group, for example, may be determined. An average for a medical code, such as a CPT code, occurring most often may be determined, such as at block 340. In an implementation, an average historical reimbursement measurement of the medical procedures (e.g., the medical codes) for a group of similar codes divided by an average historical reimbursement measurement for a medical code occurring most often within the group of similar codes may be used to estimate a relative value for the group. Thus, a relative value unit for a group in a geographic region may be computed to estimate relative value of the group in the geographic region. An estimate of relative value may be expressed mathematically for a group, as indicated below. For example, relative value unit may be computed substantially in accordance with the following:

$$\frac{\begin{matrix}Average reimbursement of \\ procedures \{ {ID}_{1} , {ID}_{2} , … , {ID}_{p} \}\end{matrix}}{\begin{matrix}Average reimbursement of most \\ frequent procedure of \{ {ID}_{1} , {ID}_{2} , … , {ID}_{p} \}\end{matrix}} = Relative Value Unit ( estimate )$$

As previously indicated, a particular medical code, such as a CPT code, corresponds to a particular medical procedure. Relative value units for additional or other groups and/or in other geographic regions, for example, may be calculated in a corresponding manner.

It is noted that an estimate of relative value, such as estimated via relative value unit, may be employed to accomplish normalization in an embodiment. Although block 340 has been described as utilizing a most frequently-occurring medical procedure, or correspondingly, a most frequently-occurring medical code, in other implementations, claimed subject matter is not limited in this respect. A host of normalization techniques are available and claimed subject matter is not limited in scope to a particular approach. For example, implementations may make use of techniques, such as weighted summations, regressions, and/or other techniques, to provide a few examples. It is not intended that claimed subject matter be limited in scope to a particular approach to normalization.

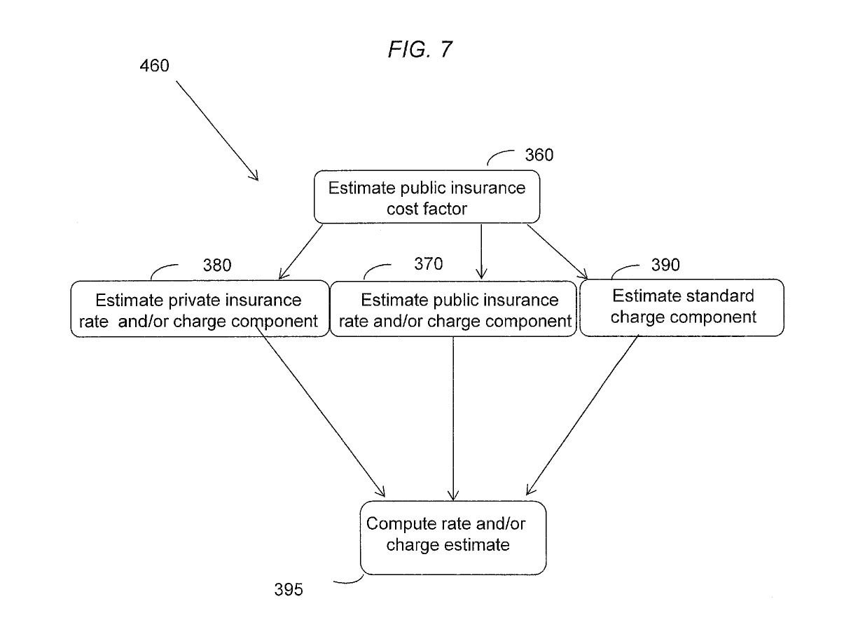

FIG. 7 is a flowchart illustrating an embodiment 460 of another method that may be employed in conjunction with estimating market-driven medical facility rates and/or charges. The method embodiment of FIG. 7, along with other figures shown and/or described herein, may be performed by computing device 20, for example, although nothing prevents performing other method embodiments within claimed subject matter. Likewise, a method embodiment, such as embodiment 460, may be performed by way of other arrangements other than the embodiment shown in FIG. 1, for example. Further, claimed subject matter may include additional blocks or alternatives other than those shown in FIG. 7 and/or may include blocks occurring in different orders than shown and/or described.

At block 360, a cost factor, such as a public insurance cost factor, for example, may be estimated. As explained below, such an estimate in an embodiment may be employed to estimate various rate components for use in estimating a market-driven medical facility charge and/or rate in an implementation. For example, in an implementation, a cost factor estimate for a group, such as CD₁, in a geographic region, for example, for public insurers may be expressed substantially in accordance with an estimate of a rate and/or charge component for a group, such CD₁, within a geographic region, normalized (e.g., divided) by an estimate of relative value for CD₁ for a geographic region for public insurers, for example. An estimate for public insurers of a rate and/or charge component for a group in a geographic region may comprise an average of historical reimbursement measurements (AHM), available from Medicare, for example, for the group and the geographic region in an implementation. Likewise, as indicated above, relative value may be estimated by a relative value unit (RVU).

Thus, a cost factor estimate for a group CD₁ for a geographic region may be substantially in accordance with

Cost Factor Estimate=AHM/RVU

where an average historical measurement (AHM) is estimated by an average of reimbursements for the medical procedures or medical codes in a group, CD₁, for a geographic region, in this example. For example, in an implementation, AHM for a group CD₁ and for a geographic region may be determined substantially according to the following expression:

$$AHM ( {CD}_{1} ) = \frac{1}{α} {\sum }_{1}^{α} {ID}_{x}$$

where CD₁ in this example has a medical procedures (e.g., medical codes, such as CPT codes) and IDₓ represents an average reimbursement for medical claims for a particular medical code within group CD₁ in the particular geographic region.

Estimates of cost factors, such as a public insurer or public insurance cost factor, for a group and a geographic region, for example, may be generated and employed in various ways. For example, in one embodiment, a public insurer cost factor estimate may be generated. For example, historical reimbursement measurements from Medicare, as mentioned previously, as an example, may be used to compute an average cost factor, as an estimate, in accordance with the approach described previously. That is, an average historical reimbursement and a relative value unit estimate may be generated to provide a cost factor estimate, such as described substantially in accordance with the expression for cost factor estimate above, which in an implementation may be employed to estimate approximately a 50th percentile for a cost factor estimate, such as for a public insurance cost factor estimate. However, claimed subject matter is not limited in this respect as different percentiles (e.g. 30th, 40th, 60th, 75th, and so forth) may be used, for example, in other embodiments. Likewise, in an alternate embodiment, a probability density function (or probability distribution function, which is the derivative of a probability density function) may be generated of a cost factor or of a component charge and/or component rate estimate, as appropriate, providing a useful mechanism for calculating a range of estimates, while also providing a meaningful visual representation. Of course, claimed subject matter is not limited to costs, charges and/or reimbursements available from, for example, CMS to compute estimates. A variety of sources of measurements may be employed and provide satisfactory results.

At block 360, therefore, an average cost factor estimate, such as for a group and a geographic region, for example, may be used to estimate a public insurer rate and/or charge component of an estimate of market-driven medical facility charges and/or rates. For example, a cost factor component estimate, such as a public insurer cost factor estimate, may be multiplied by an estimate of relative value, such as by using a computed relative value unit, as previously described. Thus, as shown at block 370, a public insurer rate and/or charge component estimate for a group and a geographic region, for example, may be estimated.

At block 390, another rate and/or charge component, here, amounts without assistance from public or private insurance providers, may be estimated using historical reimbursement measurements paid by individuals who do not have insurance or using historical reimbursement measurements paid as a result of auto insurance claims, for example. In an implementation, a standard charge estimate may comprise an amount estimated as an arithmetic mean or average for estimates of a public insurer rate and/or charge component for group in a geographic region, for example. However, it should be noted that in other implementations, an estimate reflecting other percentiles may be utilized and other estimates to adjust for inflation may be used. In some implementations, a 75th percentile, 80th percentile, or perhaps 100th percentile or another approach to estimating may be employed. It is also noted, however, as previously mentioned, for example, in conjunction with block 320 of FIG. 3, a health care CPI (likewise, rather than a health care PPI) may be applied, here, now, in this example implementation, referring to FIG. 7, to a cost factor, to adjust for inflation. Thus, a cost factor estimate, for example, such as shown in 370 (including an appropriate inflation adjustment in at least one implementation) may be multiplied by a relative value estimate, for example. As shown at block 390, a standard charge component for a group and a geographic region may therefore be estimated.

At block 380, another rate and/or charge component, here, amounts paid by private insurance providers, may be estimated using one or more scale factors and an estimate of a cost factor for a public insurer, such as in block 370. In an implementation, a cost factor estimate may be multiplied by a relative value estimate. Thus, an estimate may, in effect, comprise an amount estimated as an arithmetic mean or average of a distribution, such as for a public insurance rate and/or charge component, for a group in a geographic region, for example, scaled in the manner described below to account for private insurance. However, it should be noted that in other implementations, an estimate reflecting other percentiles than an arithmetic mean may be utilized. In some implementations, a 75th percentile, 80th percentile, or perhaps 100th percentile or another approach to estimating may be employed. Likewise, in contrast with the description above, here, now, in this example implementation, referring to FIG. 7, to adjust a cost factor for inflation a health care PPI (rather than a health care CPI, as described above) may be employed. Thus, a cost factor estimate, for example, that has been appropriately adjusted for inflation may be multiplied by a relative value estimate, for example. In an implementation, a rate and/or charge component estimate for private insurance payers may represent an amount approximately 25% higher than a rate and/or charge component estimate for public insurance payers. However, claimed subject matter is not limited in this respect. Other scale factors, such as scale factors less than approximately 1.0 (e.g. approximately 0.5, 0.75, and so forth) or scale factors greater than approximately 1.0 (e.g. proximately 1.1, 1.2, 1.4, and so forth) or other approaches to making an estimate may be employed.

At block 395, a market-drive medical facility rate and/or charge estimate may be computed using component estimates, such as those previously described. In an implementation, a charge and/or rate estimate may comprise component estimates from public insurance, private insurance, and standard charges, for example, although claimed subject matter is not limited in scope in this respect. In an implementation, at block 395, for example, a market-driven medical facility rate and/or charge estimate may comprise a weight average of components computed substantially in accordance with the following expression:

$$Estimate = \frac{1}{\begin{matrix}( \frac{0.40}{Private insurer component est .} ) + ( \frac{0.50}{Public insurer component est .} ) + \\ ( \frac{0.10}{Standard charge component est .} )\end{matrix}}$$

In an alternate (or additionally) embodiment, an estimate may involve generating a probability density or distribution function. A probability density or distribution function may comprise, for example, a first axis of a grid pertaining to a rate estimate and a second axis of a grid pertaining to historical reimbursement measurements processed in a manner as previously described to generate a distribution or density of estimates. For example, for a group, estimates may be accumulated to generate percentiles using historical reimbursement measurements. In at least one implementation, a distribution or density may be fit to a known distribution or density at least approximately, such as, for example, a Gaussian profile or a log normal distribution. However, claimed subject matter is not limited to curve fitting. For example, a density or distribution function generated from historical reimbursement measurements without curve fitting may be employed.

FIG. 5 is a diagram 400 illustrating details of a computing platform that may be employed in a system to perform methods to estimate market-driven medical facility rates and/or charges. In FIG. 5, computing platform 410 may correspond to computing platform 20 of FIG. 1 and may, in response to inquiries received via network 420, execute method embodiments related to those of FIGS. 2, 3, 4 and 7 for example. Communications interface 440, input/output module 450, one or more processing units (e.g., processors), such as processing unit 460, and memory 470, which may comprise primary memory 474 and secondary memory 476, may communicate among one another by way of communication bus 480, for example. Although the computing platform of FIG. 5 shows the above-identified elements, claimed subject matter is not limited to computing platforms comprising only these elements as other implementations may include alternative arrangements that may include additional components, fewer components, or components that function differently while achieving similar results.

A client 445, for example may comprise client resources that may include a browser utilized to, for example, view or otherwise access documents, such as, from the Internet, for example. A browser may comprise a standalone application, or an application embedded in or forming at least part of another program or operating system, etc. Client resources may also include or present a graphical user interface. An interface, such as GUI, may include, for example, an electronic display screen or various input or output devices. Input devices may include, for example, a microphone, a mouse, a keyboard, a pointing device, a touch screen, a gesture recognition system (e.g., a camera or other sensor), or any combinations thereof, etc., just to name a few examples. Output devices may include, for example, a display screen, speakers, tactile feedback/output systems, or any combination thereof, etc., just to name a few examples. In an example embodiment, a client 445 may be used may to submit a reimbursement request and receive an estimate of a market-driven rate and/or charge for a group and geographic region, based, at least in part, on computing platform 410 executing methods described herein, although claimed subject matter is not limited in this respect. Signals may be transmitted via client resources to a server system via a communications network, such as network 420, for example. A variety of approaches are possible and claimed subject matter is intended to cover such approaches.

Processing unit 460 may be representative of one or more circuits, such as digital circuits, to perform at least a portion of a computing procedure or process related to market-based medical reimbursement. By way of example but not limitation, processing unit 460 may comprise one or more processors, controllers, microprocessors, microcontrollers, application specific integrated circuits, digital signal processors, programmable logic devices, field-programmable gate arrays, and the like, or any combination thereof. In an implementation, processing unit 460 may be capable of executing machine-readable instructions to estimate a rate and/or charge for a medical procedure or a group for a base market, for example.

Memory 470 may be representative of any storage mechanism. Memory 470 may include, for example, primary memory 474 and secondary memory 476, although nothing prevents a use of additional memory circuits, mechanisms, or combinations thereof. Memory 470 may comprise, for example, random access memory, read only memory, or one or more data storage devices or systems, such as, for example, a disk drive, an optical disc drive, a tape drive, a solid state memory drive, to name just a few examples. Memory 470 may be utilized to store one or more groups, such as of similar APCs comprising a group of medical procedures or medical codes, for example. Memory 470 may also comprise a memory controller for accessing computer readable-medium 475 that may carry and/or make accessible content, code, and/or instructions, for example, executable by processing unit 460 or some other controller or processor capable of executing instructions, for example. Although computer-readable media 475 may be shown in FIG. 5 as detached from computing platform 410, nothing prevents inclusion of the computer-readable media within the enclosure of computing platform 410, and claimed subject matter is not limited in this respect.

Memory 470 may store cookies relating to one or more users, for example, and may also comprise a computer-readable medium that may carry and/or make accessible content, code and/or instructions, for example, executable by processing unit 460 or some other controller or processor capable of executing instructions, for example. A client, such as 445, may include an input device, which may comprise a computer mouse, stylus, track ball, keyboard (e.g., virtual or non-virtual), or any other device capable of receiving as an input a physical motion or the like, such as a mouse click, a key being pressed or a similar example, to generate a signal, for example, to be communicated, such as to another device, across, a network, and so forth.

Network 420 may comprise one or more communication links, processes, and/or resources to support exchanging communication signals among clients, such as 445, and computing platform 410. By way of example but not limitation, network 420 may include wireless and/or wired communication links, telephone or telecommunications systems, Wi-Fi networks, Wi-MAX networks, the Internet, the web, a local area network (LAN), a wide area network (WAN), or any combination thereof.

A computer-readable (storage) medium, such as computer-readable medium 475 of FIG. 5, typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite a change in state.

The term “computing platform” as used herein refers to a system and/or a device that includes a capability to process and/or store data in the form of signals and/or states. Thus, a computing platform, in this context, may comprise hardware, software, firmware or any combination thereof (other than software per se). Computing platform 410 and as depicted in FIG. 5 and computing platform 20 of FIG. 1 are merely examples of computing platforms, and the scope of claimed subject matter is not limited to these particular examples. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by one or more processing unit located at a computing platform.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, and/or characteristic in the singular and/or may be used to describe a plurality or some other combination of features, structures and/or characteristics. Though, it should be noted that this is merely an illustrative example and claimed subject matter is not limited to this example.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to the particular examples disclosed, but that such claimed subject matter may also include all aspects falling within appended claims and/or equivalents thereof.

1. A method comprising:
executing machine-readable instructions by one or more processors to: estimate, based at least in part on a plurality of historical reimbursement measurements for a base market, an associated market driven rate and/or charge for a group for a medical facility in said base market; said base market to generate said estimate comprising a geographic region including said medical facility.

2. The method of claim 1, wherein said geographic region comprises a region roughly radially distributed relative to said medical facility.

3. The method of claim 2, wherein said historical reimbursement measurements comprise Medicare reimbursement measurements.

4. The method of claim 2, wherein said executing machine-readable instructions comprises executing machine-readable instructions by one or more processors to estimate said market-driven rate and/or charge for a medical procedure code included in said group for said medical facility in said base.

5. The method of claim 1, wherein said executing machine-readable instructions comprises executing machine-readable instructions by one or more processors to estimate said market-driven rate and/or charge for a group of medical codes pertaining to a similar ambulatory procedure code (APC).

6. The method of claim 1, wherein said executing machine-readable instructions comprises executing machine-readable instructions by one or more processors to estimate said market-driven rate and/or charge for said group by normalization using an average of historical reimbursement measurements for said medical procedures in said group divided by an average of a plurality of historical reimbursement measurements for a most frequently-occurring medical procedure within said group.

7. The method of claim 1, wherein said executing machine-readable instructions comprises executing machine-readable instructions to estimate a public insurer component distribution for use in estimating said market-driven rate and/or charge for said group for said medical facility in said base market.

8. The method of claim 1, wherein said historical reimbursement measurements are inflation adjusted.

9. The method of claim 8, wherein said inflation adjusted historical reimbursement measures are adjusted substantially in accordance with a healthcare producer price index or a healthcare consumer price index.

10. The method of claim 9, wherein said executing machine-readable instructions comprises executing machine-readable instructions to estimate a standard charge component for use in estimating said market-driven rate and/or charge for said group for said medical facility in said base market, said standard charge component estimate comprising a mean of said public insurer component distribution adjusted for inflation using a health care consumer price index.

11. The method of claim 9, wherein said executing machine-readable instructions comprises executing machine-readable instructions to estimate a private insurer component for use in estimating said market-driven rate and/or charge for said group for said medical facility in said base market, said private insurer component estimate comprising a mean of said public insurer component distribution adjusted for inflation using a health care producer price index and scaled up by 25 percent.

12. The method of claim 1, wherein said executing machine-readable instructions comprises executing machine-readable instructions by one or more processors to identify a sufficient number of medical facilities for said base market for said medical facility.

13. The method of claim 12, wherein said sufficient number of medical facilities comprises at least a target number of medical facilities for said base market for said medical facility.

14. The method of claim 1, wherein said executing machine-readable instructions comprises executing machine-readable instructions by one or more processors to expand said geographic region by an incremental amount so as to identify at least a target number of medical facilities for said base market for said medical facility if said geographic region does not include said target number of medical facilities.

15. The method of claim 1, wherein said executing machine-readable instructions comprises executing machine-readable instructions by one or more processors to count a statistically sufficient number of historical reimbursement measurements within a group in said base market for said medical facility.

16. The method of claim 1, wherein said executing machine-readable instructions comprises executing machine-readable instructions by one or more processors to count at least 11 historical reimbursement measurements within a group in said base market for said medical facility.

17. The method of claim 1, wherein said executing machine-readable instructions comprises executing machine-readable instructions by one or more processors to expand said geographic region to count a statistically sufficient number of historical reimbursement measurements within a group in said base market for said medical facility if said geographic region does not include a statistically sufficient number.

18. An article comprising: a storage medium having stored thereon instructions executable by one or more processors to estimate, based at least in part on a plurality of historical reimbursement measurements for a base market, an associated market driven rate and/or charge for a group for a medical facility in said base market; said base market to generate said estimate comprising a geographic region including said medical facility.

19. The article of claim 18, wherein said geographic region comprises a region roughly radially distributed relative to said medical facility.

20. The article of claim 18, wherein said historical reimbursement measurements comprise Medicare reimbursement measurements.

21. The article of claim 18, wherein said instructions being further executable to count a statistically sufficient number of historical reimbursement measurements within a group in said base market for said medical facility.

22. The article of claim 18, wherein said instructions being further executable to expand said geographic region to count a statistically sufficient number of historical reimbursement measurements within a group in said base market for said medical facility if said geographic region does not include a statistically sufficient number.

23. An apparatus comprising: a computing platform to estimate, based at least in part on a plurality of historical reimbursement measurements for a base market, an associated market driven rate and/or charge for a group for a medical facility in said base market; said base market to generate said estimate comprising a geographic region including said medical facility.

24. The apparatus of claim 23, wherein said geographic region comprises a region roughly radially distributed relative to said medical facility.

25. The apparatus of claim 23, wherein said historical reimbursement measurements comprise Medicare reimbursement measurements.

26. The apparatus of claim 23, wherein said computing platform further to count a statistically sufficient number of historical reimbursement measurements within a group in said base market for said medical facility.

27. The apparatus of claim 23, wherein said instructions being further executable to expand said geographic region to count a statistically sufficient number of historical reimbursement measurements within a group in said base market for said medical facility if said geographic region does not include a statistically sufficient number.
